(19) United States
(12) Patent Application Publication
(10) Pub. No.: US 2025/0128421 A1
(43) Pub. Date: Apr. 24, 2025

(54) DATA PROCESSING DEVICE AND METHOD FOR ROBOT CONTROL

(71) Applicant: COGA ROBOTICS CO.,LTD., Seoul (KR)

(72) Inventors: Ilhong SUH, Seoul (KR); Yongnyeon KIM, Seoul (KR); Dongwook KO, Gyeonggi-do (KR)

(21) Appl. No.: 19/006,250

(22) Filed: Dec. 31, 2024

Related U.S. Application Data
(63) Continuation of application No. PCT/KR2023/010267, filed on Jul. 18, 2023.

(30) Foreign Application Priority Data
Jul. 19, 2022 (KR) 10-2022-0088670

(51) Int. Cl. B25J 9/16

(52) U.S. Cl. CPC B25J 9/1694

(57) ABSTRACT

A data processing device and method for robot control are disclosed. In the data processing device for robot control, a data processing device according to one embodiment comprises: a memory which stores data; and a processor which executes an instruction stored in the memory, wherein the processor: receives detection results from a sensor driver; controls a robot according to the detection results by executing a robot control program including a plurality of modules; processes data transmission between the plurality of modules; and generates a response signal in response to a change in the data stored in the memory due to the processing of the data.

### CROSS-REFERENCE TO RELATED APPLICATION

This application is a US Bypass Continuation Application of International Application No. PCT/KR2023/010267, filed on Jul. 18, 2023, which claims priority to and the benefit of Korean Patent Application No. 10-2022-0088670, filed on Jul. 19, 2022, the disclosure of which is incorporated herein by reference in its entirety.

### BACKGROUND

### Technical Field

The following embodiments relate to a data processing device and a method for robot control.

### Background Art

A robot operating system (ROS) provides hardware abstraction, lower-level device control, implementation of commonly used functions, message passing between processes, package management, libraries required for the development environment, and various development and debugging tools required when developing robot applications.

The ROS is a robot platform such as an operating system for developing a robot application program. The ROS includes a hardware platform as the hardware abstraction, and the ROS is a software platform for supporting the development of the robot application software and has the same function as an operating system usable in heterogeneous hardware.

However, the ROS has problems of low security, high overhead, and communication delay. Therefore, a data processing technology that generates low overhead while maintaining high security is required.

### SUMMARY

### Technical Problem

Embodiments may provide a data processing technology for robot control.

However, a technical object is not limited to the technical objects described above, and other technical objects may exist.

### Technical Solution

A data processing device for robot control according to an embodiment may include: a memory which stores data; and a processor which executes an instruction stored in the memory, and the processor may receive detection results from a sensor driver; controls a robot according to the detection results by executing a single robot control program including a plurality of modules, process data transmission between the plurality of modules; and generate a response signal in response to a change in the data stored in the memory due to the processing of the data.

The plurality of modules may directly access the data stored in the memory, and process the data, and process the data transmission between the plurality of modules by using a virtual data bus based on a variable reference method, and the response signal may be implemented as a condition variable.

A mutual data sharing method of the plurality of modules may be standardized.

The processor may include a sensor manager for managing a sensor driven by the sensor driver, a module manager for managing the plurality of modules, a data sharing manager for sharing the data, and a debugging manager for debugging the plurality of modules.

A data processing method for robot control according to an embodiment may include: receiving detection results from a sensor driver; executing a single robot control program including a plurality of modules to control a robot according to the detection results; processing data transmission between the plurality of modules; and generating a response signal in response to a change in the data stored in the memory due to the processing of the data.

### BRIEF DESCRIPTION OF THE DRAWINGS

FIG. 1 is a schematic block diagram of a data processing device according to an embodiment.

FIG. 2 illustrates an example of a conventional collaborative method for robot control.

FIG. 3 illustrates another example of a conventional collaborative method for robot control.

FIG. 4 illustrates an example of a collaborative method for robot control using the data processing device illustrated in FIG. 1.

FIG. 5 is a diagram for describing a data processing operation.

FIG. 6 is a diagram for describing a robot control process of the data processing device illustrated in FIG. 1.

FIG. 7 is a diagram for describing a robot control solution.

FIG. 8 is a diagram for describing a process of measuring a delay time.

FIG. 9 illustrates a delay time in a conventional data processing method.

FIG. 10 illustrates a delay time of the data processing device illustrated in FIG. 1.

FIG. 11 illustrates a flowchart of an operation of the data processing device illustrated in FIG. 1.

### DETAILED DESCRIPTION

Specific structural or functional descriptions of the embodiments are disclosed for illustrative purposes only and may be modified and implemented in various forms. Accordingly, the actually implemented forms are not limited to the specific disclosed form, and the scope of the present invention includes changes, equivalents, or substitutes included in the technical spirit.

Terms such as first or second may be used to describe various components, but these terms should be interpreted only for the purpose of distinguishing one component from another component. For example, a first component may be referred to as a second component, and similarly, the second component may be referred to as the first component.

It should be understood that, when it is described that a component is “connected to” another component, the component may be directly connected to or access the other component or a third component may be present therebetween.

A singular form includes a plural form if there is no clearly opposite meaning in the context. In this document, each of phrases such as “A or B”, “at least one of A and B”, “at least one of A or B”, “A, B, or C”, “at least one of A, B, and C”, and “at least one of A, B, or C” may include at least one or all possible combinations of items listed together with a corresponding phrase among the phrases. In the present specification, it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

If it is not contrarily defined, all terms used herein including technological or scientific terms have the same meanings as those generally understood by a person with ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined here.

The term “module” used in this document may include a unit implemented as hardware, software, or firmware, and may be used intercompatibly with a term such as logic, a logic block, a part, or a circuit, for example. The module may become an integrally configured part or a minimum unit or a part of the part, which performs one or more functions. For example, according to an embodiment, the module may be implemented in the form of an application-specific integrated circuit (ASIC).

The term “unit” used in this document means software and hardware components such as FPGA or ASIC and the “unit” performs predetermined roles. However, the “unit” is not a meaning limited to software or hardware. The “unit” may be configured to reside on an addressable storage medium and may be configured to play back one or more processors. For example, the “unit” may include components such as software components, object oriented software components, class components, and task components, processes, functions, attributes, procedures, subroutines, segments of a program code, drivers, firmware, microcodes, circuitry, data, databases, data structures, tables, arrays, and variables. Functions provided in the components and the “units” may be combined into a smaller number of components and “units” or further separated into additional components and “units”. Moreover, the components and the ‘units’ may be implemented to reproduce one or more CPUs in a device or a secure multimedia card Further, the ‘unit’ may include one or more processors.

Hereinafter, embodiments are described in detail with reference to the attached drawings. In the description with reference to the accompanying drawings, the same components are assigned the same reference numerals regardless of the reference numerals, and redundant descriptions thereof will be omitted.

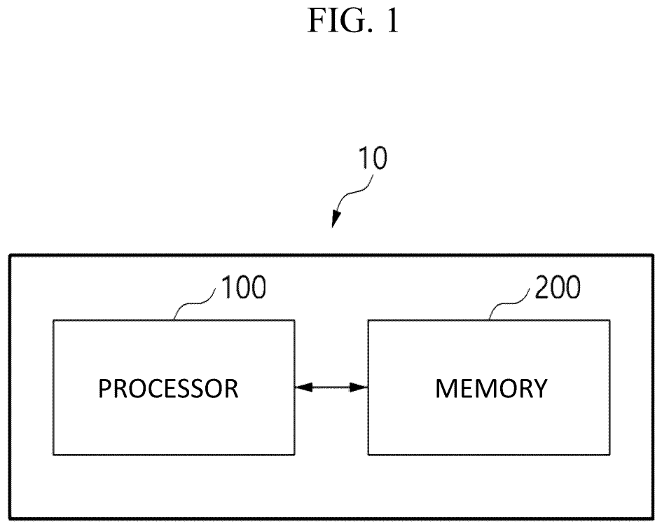

FIG. 1 is a schematic block diagram of a data processing device according to an embodiment.

Referring to FIG. 1, the data processing device 10 may process data. The data processing device 10 may mean data that is symbolized or digitized in a form that may operate a program. The data may take forms of letters, numbers, sounds, pictures, etc., which may be processed by a computer.

The data processing device 10 may perform data processing for robot control. The data processing device 10 may generate a signal for robot control.

The data processing device 10 may transfer the data to an application for robot control. The application for robot control may include a backend application, a frontend application, and a remote application.

The data processing device 10 may provide a standardized development environment to a plurality of developers. The data processing device 10 may standardize a sharing method of data, and perform data processing based on the standardized sharing method.

The data processing device 10 may be implemented as a printed circuit board (PCB) such as a motherboard, an integrated circuit (IC), or a system on chip (SoC). For example, the data processing device 10 may be implemented as an application processor.

Further, the data processing device 10 may be implemented in a personal computer (PC), a data server, or a handheld device.

The handheld device may be implemented as a laptop computer, a mobile phone, a smart phone, a tablet PC, a mobile internet device (MID), personal digital assistant (PDA), enterprise digital assistant (EDA), a digital still camera, a digital video camera, a portable multimedia player (PMP), a personal navigation device (PND), or a portable navigation device, a handheld game console, e-book, or a smart device. The smart device may be implemented as a smart watch, a smart band, or a smart ring.

The data processing device 10 includes a processor 100 and a memory 200.

The processor 100 may receive data. The processor 100 may receive data from the outside or the memory 200. The processor 100 may include a reception interface.

The processor 100 may process data stored in the memory 200. The processor 100 may execute a computer-readable code (e.g., software) stored in the memory 200 and instructions generated by the processor 100.

The “processor 100” may be a data processing device implemented as hardware having a circuit having a physical structure for executing desired operations. For example, the desired operations may include code or instructions contained in the program.

For example, the data processing device implemented as the hardware may include a microprocessor, a central processing unit, a processor core, a multi-core processor, a multiprocessor, an application-specific integrated circuit (ASIC), or a field programmable gate array (FPGA).

The processor 100 may receive a detection result from a sensor driver.

The processor 100 may control a robot according to a detection result by executing a robot control program including a plurality of modules.

The plurality of modules may directly access data stored in the memory 200, and process the data.

The processor 100 may process data transmission between the plurality of modules. The processor 100 may process the data transmission between the plurality of modules by using a virtual data bus based on a variable reference method.

The processor 100 may generate a response signal in response to a change of the data stored in the memory 200 by the processing of the data. The response signal may be configured as a condition variable.

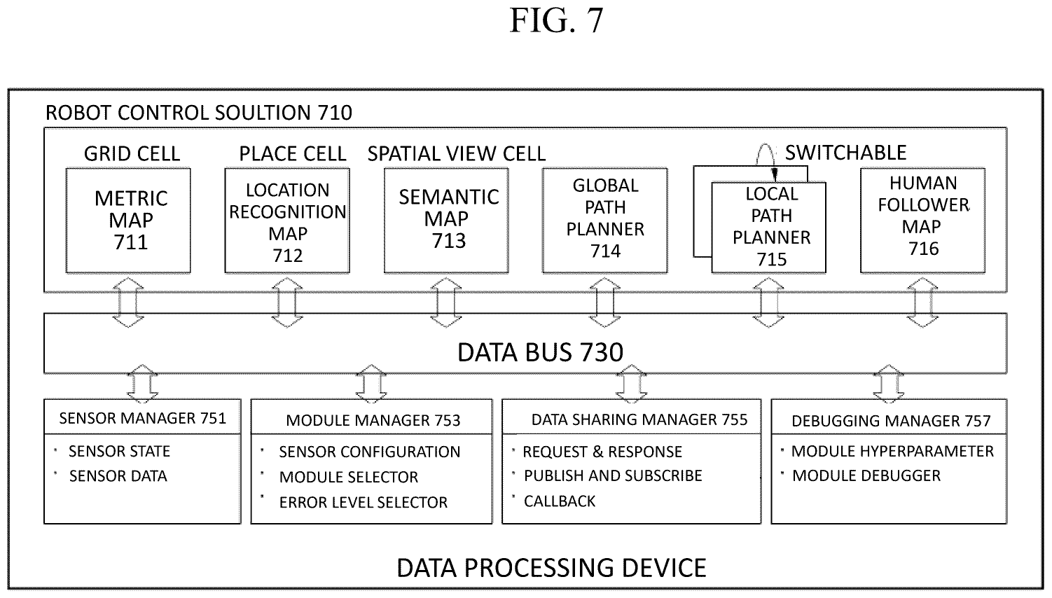

The processor 100 may include a sensor manager for managing a sensor drive by the sensor driver and a module manager for managing the plurality of modules. The processor 100 may include a data sharing manager for sharing data and a debugging manager for debugging the plurality of modules. The sensor manager, the module manager, the sharing manager, and the debugging manager are described in detail with reference to FIG. 7.

The memory 200 may store data. The processor 100 may store instructions (or program) executable by the processor 100. For example, the instructions may include instructions for executing an operation of the processor and/or an operation of each component of the processor.

The memory 200 may be implemented as a volatile memory device or a non-volatile memory device.

The volatile memory device may be implemented as dynamic random access memory (DRAM), static random access memory (SRAM), thyristor RAM (T-RAM), zero capacitor RAM (Z-RAM), or twin transistor RAM (TTRAM).

The non-volatile memory device may be implemented as an electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, molecular electronic memory device, or insulator resistance change memory.

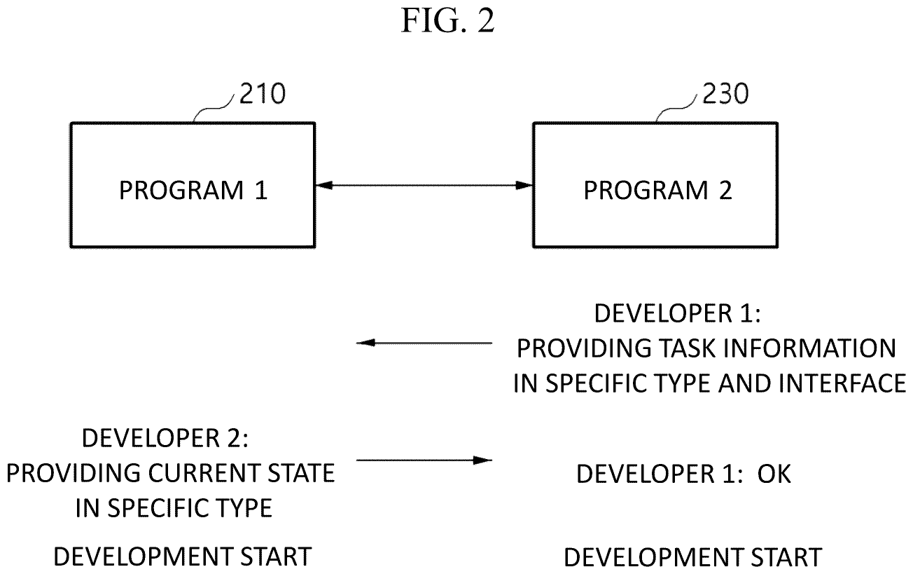

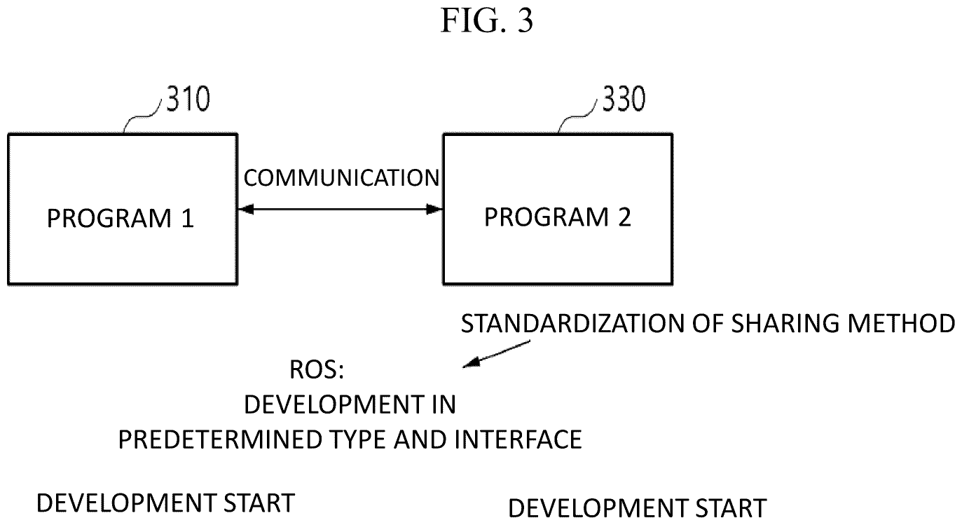

FIG. 2 illustrates an example of a conventional collaborative method for robot control and FIG. 3 illustrates another example of a conventional collaborative method for robot control.

Referring to FIGS. 2 and 3, a conventional robot control system can be implemented with a plurality of independent programs (e.g., program 1 210, program 2 230, program 1 310, or program 2 330). The independent programs are forbidden from accessing each other at an operating system (OS) level.

To create one application with the plurality of independent programs, the programs need to share information thereof with each other. In an existing collaboration method, application development is done by providing a random developer (e.g., developer 1) task information to another developer (e.g., developer 2) in a specific type and interface, and the other developer transfers a current state thereof in a received specific type. When a new developer develops a task, renegotiation between developers is required.

A robot operating system (ROS) based robot software framework may standardize an information sharing method. When using the ROS, developers may perform development according to a standard set by the ROS, so the developers may perform development independently without having to make promises or negotiate I/O (input/output) with other developers. That is, in the case of the ROS, various developers may configure a system by switching modules, and renegotiation may not be required even when a new developer develops a task.

However, the ROS is a platform for developers and focuses on scalability rather than performance, so the ROS has low security and may have communication overhead and delay.

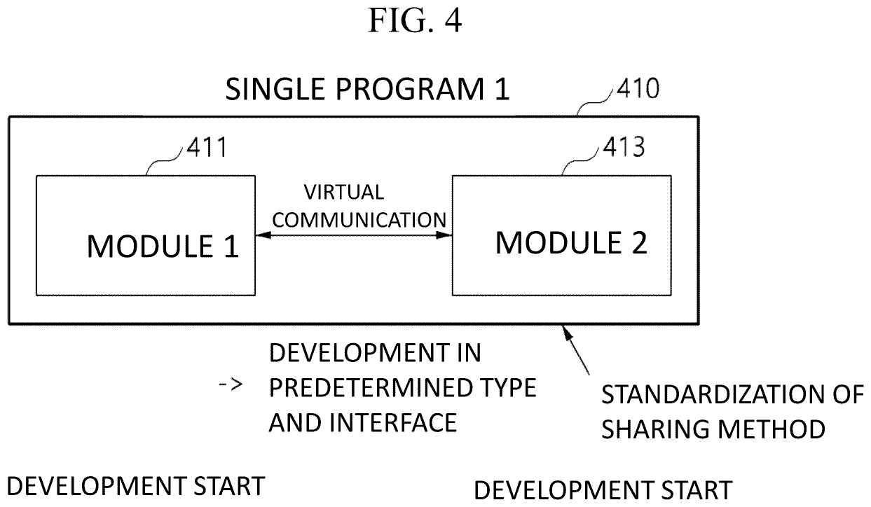

FIG. 4 illustrates an example of a collaborative method for robot control using the data processing device illustrated in FIG. 1.

Referring to FIG. 4, a processor (e.g., the processor 100 of FIG. 1) may implement a robot control framework using one program (e.g., single program 1 410). The processor 100 may enable direct information exchange between module 1 411 and module 2 413 using single program 1 410.

Through this, the processor 100 may enhance security in data transmission between modules (e.g., module 1 411 and module 2 413) and also reduce the communication delay while eliminating overhead.

The processor 100 may provide a development environment that performs standardized communication by standardizing a method of exchanging information between modules. The processor 100 may enable developers of different modules to perform development independently by using the standardized information exchange method. Through this, the processor 100 may facilitate module switching.

The processor 100 may process data transmission between module 1 411 and module 2 413 in a virtual communication method. The processor 100 may process the data transmission between the plurality of modules by using a virtual data bus based on a variable reference method.

The processor 100 achieves high security, low overhead, and fast responsiveness to contribute to commercial use for robot system development. The processor 100 may enable development to be performed without renegotiation even when the new developer develops the task by utilizing the plurality of modules included in the single program, and may enable a robot control system to be configured by switching modules of various developers.

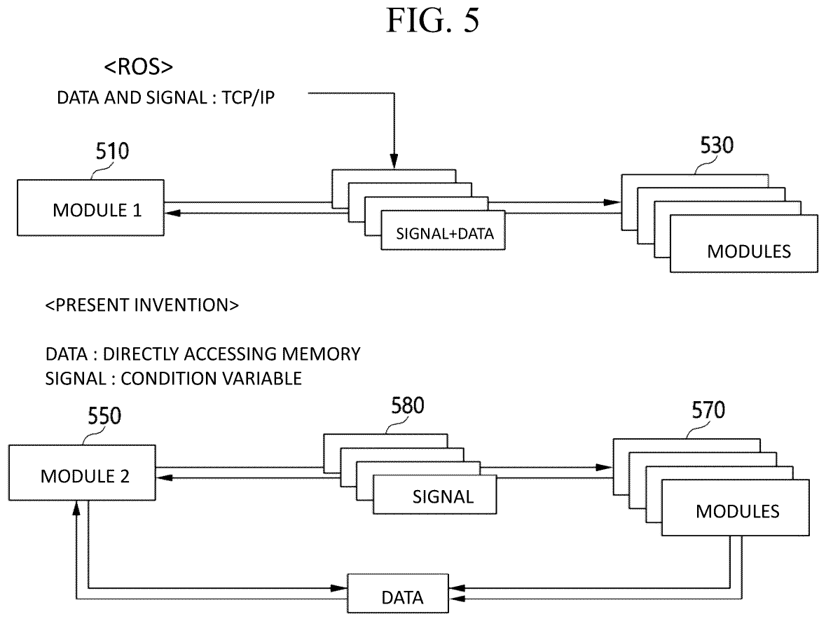

FIG. 5 is a diagram for describing a data processing operation.

Referring to FIG. 5, when using the ROS, module 1 510 and modules 530 may exchange data with each other through communication. At this time, data and related signals may be directly transmitted and received in the form of a packet via a TCP/IP method, thereby performing communication between the modules 510 and 530. At this time since data is directly transmitted and received through communication between modules, respective modules 510 and 530 may accurately recognize a time when data is transmitted and received, but communication overhead may occur in the case of large-capacity data transmission and reception. For example, in a situation where module 1 510 must transmit data to N separate modules, a communication load for module 1 510 may increase exponentially, and since data is transmitted using communication, there may be a problem of lowering external security.

On the other hand, the processor (e.g., the processor 100 of FIG. 1) may record data which module 2 550 transmitting data is to transmit, to a sharing memory, and modules 570 receiving data directly accesses the sharing memory to utilize the recorded data. The sharing memory may mean a memory which is shared between the modules 550 and 570, and which is accessible by all modules. Since the modules 570 receiving data may not immediately know a time when module 2 550 providing data records data in the sharing memory in real time, an additional means may be requested to utilize data immediately at the time when the data is recorded. In the processor, module 2 550 may transmit a signal 580 indicating that the data is recorded in the memory to the modules 570 in the form of a condition variable along recording the data in the memory. Conversely, in a situation where the modules 570 acquire the recorded data, the modules 570 may transfer the signal 580 indicating that the data is transferred to the modules 570 to module 2 550 in a conditional variable method. For example, the processor may share data between modules by a method of sending a signal regarding whether to record the data or whether to acquire the data by making it a condition that the data is recorded in the memory or the data is recorded from the memory through the module.

A time when the data is recorded and a time when the data is acquired are transmitted to the modules 550 and 570 through the signal 580 in real time through the above method, so data transmission may be made without an additional means (e.g., a for loop method) in a process for utilizing data immediately at a time when the data is recorded in the sharing memory. This may provide a communication method with enhanced communication delay and security.

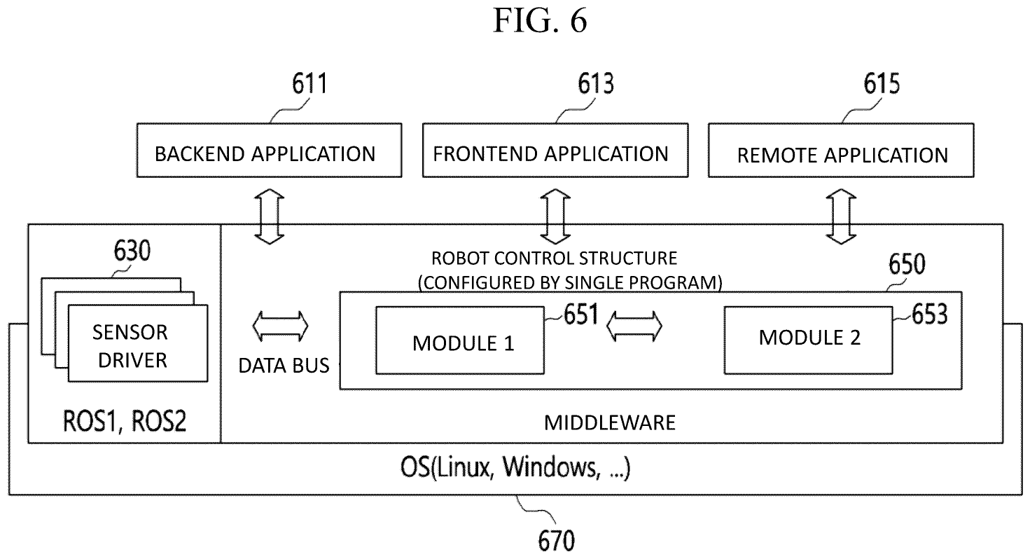

FIG. 6 is a diagram for describing a robot control process of the data processing device illustrated in FIG. 1.

Referring to FIG. 6, the processor (e.g., the processor 100 of FIG. 1) may process data using middleware. The processor 100 may operate the middleware on an operating system (OS) 670. For example, the OS 670 may include Linux or Windows.

The middleware may exchange data with a backend application 611, a frontend application 613, and/or a remote application 615.

The middleware may receive a detection result from a sensor driver 630. The detection result may be transmitted via a data bus. The middleware may include a robot control structure 650 consisting of a single program. The single program may include a plurality of modules (e.g., module 1 651 and module 2 653). Module 1 651 and module 2 653 may exchange data through a virtual data bus.

The middleware may be implemented as program internal middleware (PIM). The processor 100 may eliminate communication overhead by using the PIM. Further, the middleware may also be implemented low-cost and low-specification central processing units (CPUs) by using the PIM, which may reduce cost. The processor 100 may provide an independent development environment for each module and may be applied to various robots.

FIG. 7 is a diagram for describing a robot control solution to which a method according to an embodiment is applied.

Referring to FIG. 7, the processor (e.g., the processor 100 of FIG. 1) may process data using middleware.

The middleware may include a robot control solution 710. The robot control solution 710 may include a grid cell including a metric map 711, a place cell including a location recognition map 712, and a spatial view cell including a semantic map 713. The robot control solution 710 may include a global path planner 714, a switchable local path planner 715, and a human follower map 716.

The place cell and the grid cell collaborate with each other to enhance location precision and prevent loss of a location. In other words, the grid cell and the place cell may provide a kidnapping-free function.

The robot control solution 710 may exchange data with a plurality of managers through a data bus 730. The plurality of managers may include a sensor manager 751, a module manager 753, a data sharing manager 755, and a debugging manager 757.

The sensor manager 751 may manage a sensor state and sensor data. The module manager 753 may include a sensor configuration, a module selector, and an error level selector. The data sharing manager 755 may process a request and a response for data and manage publishing and subscription of data. The data sharing manager 755 may manage a callback.

The debugging manager 757 may manage a module hyperparameter and a module debugger.

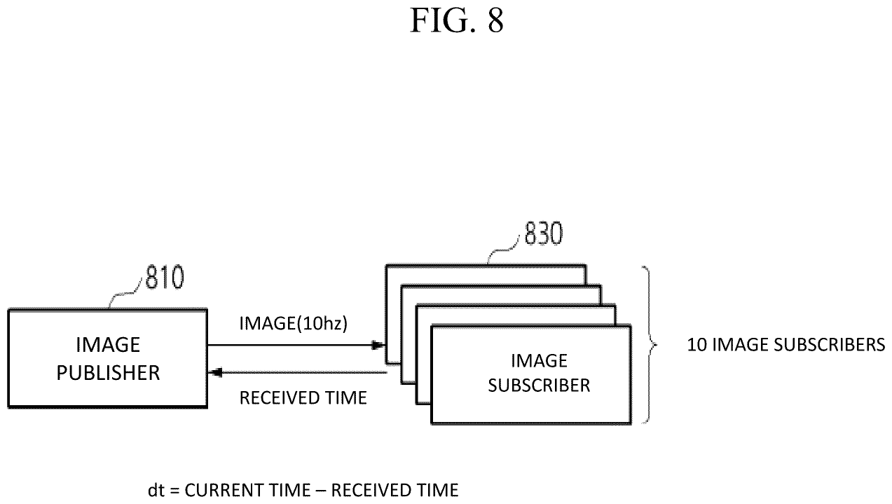

Hereinafter, an experiment for measuring the performance of the data processing device (e.g., the data processing device 10 of FIG. 1) will be described with reference to FIGS. 8 to 10.

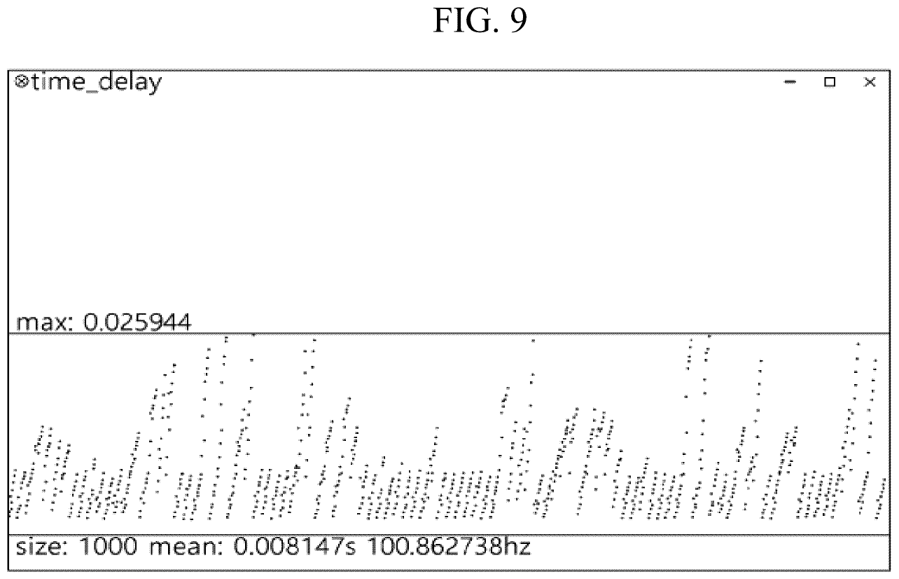

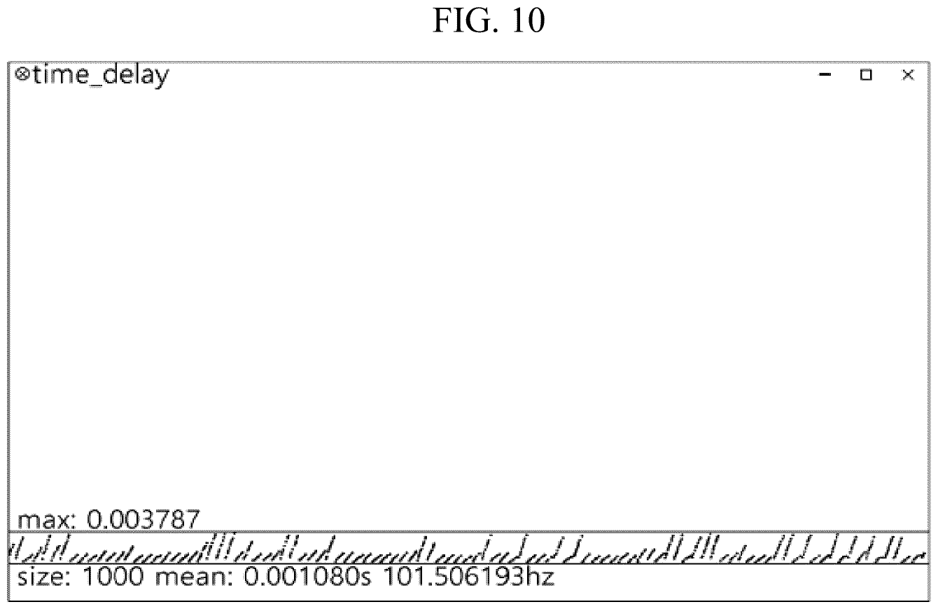

FIG. 8 is a diagram for describing a process of measuring a delay time, FIG. 9 illustrates a delay time in a conventional data processing method, and FIG. 10 illustrates a delay time of the data processing device illustrated in FIG. 1.

Referring to FIGS. 8 to 10, an image publisher 810 and an image subscriber 830 may transmit images at 10 Hz. The image subscriber 830 may transmit a received time to the image publisher 810.

The processor (e.g., the processor 100 of FIG. 1) may calculate a delay time (e.g., dt) by subtracting the received time from a current time. For example, the processor may calculate the delay time as shown in Equation 1.

$$Dt = now - receivedtime \qquad [ Equation 1 ]$$

Here, now may mean the current time, and received time may mean the received time.

The conventional method of FIG. 9 had a delay time of about 0.005 seconds, and the data processing device of FIG. 10 (e.g., the data processing device 10 of FIG. 1) has a delay time of 0.0007 seconds. In other words, the data processing device 10 may shorten the delay time to about 1/7.

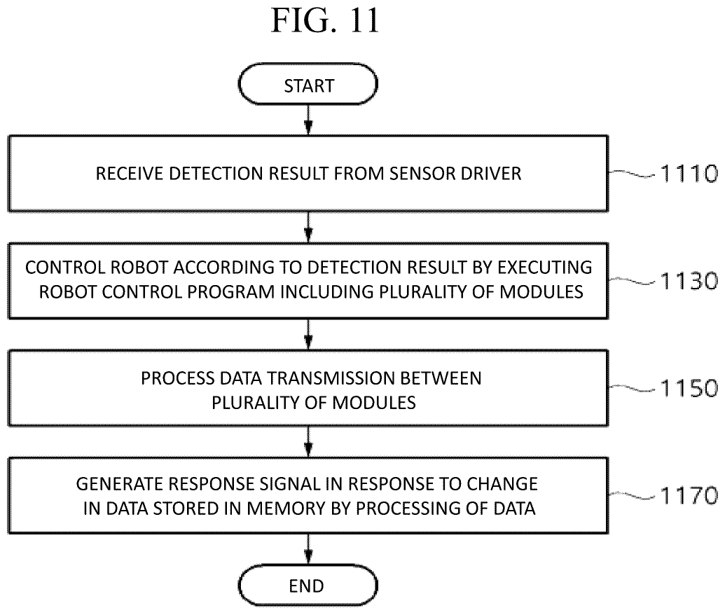

FIG. 11 illustrates a flowchart of an operation of the data processing device illustrated in FIG. 1.

Referring to FIG. 11, the processor (e.g., the processor 100 of FIG. 1) may receive a detection result from the sensor driver (1110).

The processor 100 may control a robot according to the detection result by executing a robot control program including a plurality of modules (1130).

The plurality of modules may directly access data stored in the memory 200, and process the data.

The processor 100 may process data transmission between the plurality of modules (1150). The processor 100 may process the data transmission between the plurality of modules by using a virtual data bus based on a variable reference method. The method of transmitting the data may be the same as the method described above.

The processor 100 may generate a response signal in response to a change of the data stored in the memory 200 by the processing of the data (1170). The response signal may be implemented as a condition variable.

The processor 100 may include a sensor manager for managing a sensor drive by the sensor driver and a module manager for managing the plurality of modules. The processor 100 may include a data sharing manager for sharing data and a debugging manager for debugging the plurality of modules.

The embodiments can provide high security, low overhead, and fast response in performing robot control by performing data processing using a standardized information exchange method.

By applying the data standardization technology and operation support technology according to the present invention, a plurality of programs written independently of each other can be operated in the same manner as when programs communicate with each other within a single computing system, without a coordination process or communication between programs. Through this, the present invention can provide a means to enable collaborative programming through independent programs.

The devices described above may be implemented by hardware components, software components, and/or combinations of the hardware components and the software components. For example, the devices and components described in the embodiments may be implemented by using one or more universal computers or special-purpose computers like any other devices a processor, controller, an arithmetic logic unit (ALU), a digital signal processor, a microcomputer, a field programmable gate array (FPGA), a programmable logic unit (PLU), a microprocessor, or any other device capable of executing and responding to an instruction. A processing device may perform an operating system (OS) and one or more software applications executed on the operating system. Further, the processing device may access, store, operate, process, and generate data in response to execution of software. For convenience of understanding, there is a case where it is described that one processing device is used, but those skilled in the art may know that the processing device may include a plurality of processing elements and/or a plurality of types of processing elements. For example, the processing device may include a plurality of processors or one or more processors or one controller. Further, another processing configuration such as a parallel processor is also available.

The software may include a computer program, code, instructions, or a combination of one or more thereof, and configure the processing unit to operate as desired, or instruct a processing device independently or collectively. The software and/or the data may be interpreted by the processing device or may be permanently or temporarily embodied in any type of machine, component, physical device, virtual equipment, computer storage medium or device, or a transmitted signal wave in order to provide instructions or data to the processing device. The software may be distributed on a computer system connected through the network and stored or executed by a distributed method. The software and the data may be stored in one or more computer readable recording media.

The method according to the embodiment may be implemented in a form of a program command which may be performed through various computer means and recorded in the computer readable medium. The computer readable medium may include a program command, a data file, a data structure, etc., singly or combinationally. The program command recorded in the medium may be specially designed and configured for the embodiment, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler. The hardware device may be configured to be operated with one or more software modules in order to perform the operation of the embodiment and vice versa.

As described above, although the embodiments have been described by the limited embodiments and drawings, those skilled in the art can perform various technical modifications and variations from the description. For example, the described techniques are performed in a different order from the described method, and/or components such as a system, structure, device, circuit, etc., described are collected or combined in a form different from the described method, or even if the components are replaced or substituted by other components or an equivalent, an appropriate result can be achieved.

Therefore, other implementations, other embodiments and claims and equivalents fall within the scope of the following claims.

What is claimed is:

1. A data processing device for robot control, comprising:
a memory which stores data; and
a processor which executes an instruction stored in the memory,
wherein the processor:
receives detection results from a sensor driver,
controls a robot according to the detection results by executing a robot control program including a plurality of modules,
processes data transmission between the plurality of modules, and
generates a response signal in response to a change in the data stored in the memory due to the processing of the data.

2. The data processing device of claim 1, wherein the plurality of modules:
directly access the data stored in the memory, and process the data, and
process the data transmission between the plurality of modules by using a virtual data bus based on a variable reference method, and
the response signal is implemented as a condition variable.

3. The data processing device of claim 2, wherein a mutual data sharing method of the plurality of modules is standardized.

4. The data processing device of claim 1, wherein the processor includes:
a sensor manager for managing a sensor driven by the sensor driver,
a module manager for managing the plurality of modules,
a data sharing manager for sharing the data, and
a debugging manager for debugging the plurality of modules.

5. A data processing method for robot control, comprising:
receiving detection results from a sensor driver;
executing a single robot control program including a plurality of modules to control a robot according to the detection results,
processing data transmission between the plurality of modules; and
generating a response signal in response to a change in the data stored in the memory due to the processing of the data.
